(19) United States
(12) Patent Application Publication
(10) Pub. No.: US 2012/0321896 A1
(43) Pub. Date: Dec. 20, 2012

(54) RASAGILINE MESYLATE HAVING LARGE PARTICLE SIZE AND A PROCESS FOR PREPARATION THEREOF

(76) Inventors: Kuppuswamy Nagarajan, Banglore (IN); Rajiv Kumar, Maharashtra (IN); Dharmesh Kumar Arvindbhai Patel, Maharashtra (IN); Jaman Mandaviya, Maharashtra (IN)

(21) Appl. No.: 13/575,989

(22) PCT Filed: Jan. 28, 2011
(86) PCT No.: PCT/IN2011/000056

§ 371 Date: Jul. 30, 2012

(30) Foreign Application Priority Data
Feb. 1, 2010 (IN) 237/MUM/2010

(51) Int. Cl. B29B 9/12; B32B 5/16

(52) U.S. Cl. 428/402; 264/5

(57) ABSTRACT

The present invention provides particulate rasagiline mesylate having a particle size of about 255 microns to about 590 microns. Particularly it relates to a process of preparing rasagiline mesylate having large particle size by crystallisation techniques and devoid of comminution techniques to control particle size.

### FIELD OF THE INVENTION

The invention is directed to large particulate Rasagiline mesylate. Particularly it relates to a process of preparing rasagiline mesylate having large particle size.

### BACKGROUND OF THE INVENTION

R (+)-N-propargyl-1-aminoindan (referred to hereinafter as R (+) PAI or rasagiline) has been reported to be a selective inhibitor of the B-form of the enzyme monoamine oxidase (“MAO-B”) and is useful in treating Parkinson's disease and various other conditions.

Rasagiline mesylate is approved for treating Parkinson's disease either as monotherapy or as an adjunct with other treatments. See, e.g. AGILECT®, Physician's Desk Reference (2007), 61st Edition, Thomson Healthcare.

U.S. Pat. No. 5,532,415 (referred to hereinafter as US'415) discloses R (+)-N-propargyl-1-aminoindan, its preparation, and various pharmaceutically acceptable salts thereof, as well as pharmaceutical compositions containing same. Example 6B of US'415 discloses a process for the preparation of rasagiline mesylate by reacting di-(R-(+)-N-propargyl-1-aminoindan)tartrate in IPA. Thus the process necessitates the use of Resolution techniques with the like of tartaric acids and is thus cumbersome and not industrially feasible.

PCT Publication No. WO 2006/091657 discloses solid pharmaceutical formulations of rasagiline comprising an amount of the mixture of particles of a pharmaceutically acceptable salt of rasagiline, wherein more than 90% of the total amount by volume of rasagiline salt particles have a size of less than 250 microns.

PCT publication WO 2009/122301 discloses resagiline mesylate particles having a 90 volume-percent of particles (D₉₀) with a size of about 600 microns to 1500 microns achieved by recrystallisation of rasagiline mesylate from a solvent medium comprising an ester solvent and an alcoholic solvent. It also discloses a process for controlling the particle size by milling to afford particles wherein 90 volume-percent of the particles (D₉₀) have a size of about 255 microns to about 1400 microns.

The solid state physical properties of an active pharmaceutical ingredient (API), such as rasagiline salt, can be very important in formulating a drug substance and can have profound effects on the ease of formulation. Particle size, for example, may affect the flowability and mixability of a drug substance. Small particles are also filtered and washed more slowly during isolation processes, and thus may increase the time and expense of manufacturing a drug formulation.

An advantage of the present invention is that it eliminates the need of cumbersome grinding and milling operation techniques followed by prior art. Milling operations may reduce the crystallinity of the final API, and also result in yield loss and involve high capital costs. Besides, milling operations are also associated with other potential problems of the like of Dust explosion hazards, Potential worker exposure issues requiring special containment equipment, and are also time and labour intensive operations.

Thus the prior art processes disclose milling operations as the only solution to obtain particles of rasagiline particles of the desired range suitable for uniform distribution of the drug substance in a tablet blend and such other formulations.

Thus there is a need in the art for a process for preparing rasagiline mesylate having a large particle size in an efficient, economically viable, high yielding and industrially viable manner.

The inventors of the present invention have developed a process of final form crystallization of rasagiline mesylate typically focusing on impurity purging with the primary goal of achieving rasagiline mesylate of not just high purity and yield but also in a desirably larger particle size in the range of about 255 microns to about 590 microns by crystallization and devoid of comminution techniques to control particle size.

### SUMMARY OF THE INVENTION

Thus according to an aspect of the present invention is provided Rasagilinc mesylate having a 90 volume-percent of the particles (D₉₀) with a size of about 255 microns to about 590 microns obtained by crystallisation techniques and devoid of comminution techniques to control particle size.

Thus according to another aspect of the present invention is provided a process for preparing rasagiline mesylate particles by recrystallisation.

The aspects of the present invention can be summarized in the following steps;
A. Rasagiline mesylate having a 90 volume-percent of the particles (D₉₀) with a size of about 255 microns to about 590 microns, wherein the particle size is controlled by crystallisation techniques and is devoid of comminution operations.
B. A process for preparing particulate rasagiline mesylate comprising the steps of:
   i. providing a slurry of rasagiline mesylate in a suitable solvent.
   ii. heating the slurry of step i upto reflux temperature to obtain a clear solution;
   iii. gradual cooling to room temperature;
   iv. recovering rasagiline mesylate wherein atleast 90% of the particles have a particle size of about 255 microns to about 590 microns.
C. The process according to steps A and B wherein the solvent is selected from a group comprising alcohols, esters, ethers, ketones, nitrites, hydrocarbons and the like or mixtures thereof.
D. The process according to step C, wherein the preferred solvent is an alcohol.

### DETAILED DESCRIPTION OF THE INVENTION

Before the present process and methods are described, it is to be understood that this invention is not limited to particular compounds, formulas or steps described, as such may, of course, vary. It is also to be understood that the terminology used herein is for the purpose of describing particular embodiments oily, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context clearly dictates otherwise. Thus, for example, reference to “a compound” includes a plurality of such compounds and reference to “the step” includes reference to one or more step and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

The present invention provides Rasagiline mesylate having a 90 volume-percent of the particles (D₉₀) with a size of about 255 microns to about 590 microns obtained by crystallisation techniques and devoid of comminution techniques to control particle size.

The present invention also provides a process for preparing particulate rasagiline mesylate wherein at least 90% of the particles, by volume, have a particle size of about 255 microns to about 590 microns.

Rasagiline mesylate having a large particle size, such as that described above, may be filtered off and dried easily. Large particle size rasagiline mesylate allows the preparation of a final product containing less residual solvent and water.

The invention provides a process for preparing particulate rasagiline mesylate wherein at least 90% of the particles have a particle size of about 255 microns to about 590 microns.

The process of the invention allows the dissolution rate of the rasagiline mesylate to be controlled and also allows the preparation of pharmaceutical compositions that exhibit an improved bioavailability of rasagiline mesylate. Rasagiline mesylate of the present invention is thus well suited for formulations.

“Particulate rasagiline mesylate” refers to rasagiline mesylate in powder or granular form comprised of a plurality of discrete particles, or individual units of mass. The individual particles of the particulate rasagiline mesylate of the present invention can be regular-shaped, or they can have an irregular shape. The individual particles of a sample or aliquot of the solid particulate rasagiline mesylate of the present invention are not of uniform size. Rather, a sample or aliquot of a solid particulate rasagiline mesylate of the present invention is comprised of particles of different sizes that can be size-classified or distributed in an array of discrete, adjacent intervals of particle size. When the particles have an irregular shape, nominal size of a particle refers to the dimension of the so-called equivalent sphere, a concept known in the field of particle size analysis. If the size of the intervals is small enough, the array of particle sized approaches a continuum of particle sizes. This collection of discrete particle size intervals together with their population is referred to as the particle size distribution (PSD)

The term “large particle size” as used here refers to particles of rasagiline mesylate having D₉₀ in a range of about 255 microns to about 590 microns.

Measurement and characterization of particle size distributions is known in the art. It is possible to compare samples of particulate rasagiline mesylate on the basis of individual points on a cumulative particle size distribution curve. The measurements are represented as d(0.X)-Y (where X and Y are Arabic numerals), each “d” describing an individual point on a cumulative PSD curve. The number “X” represents the percentage (number, volume, or weight) of particles in the population having a nominal size up to and including “Y”. Thus, D₉₀ or d(0.9) of greater than 255 μm is a characteristic of a PSD in which 90% (number, volume, or weight) of the particles in a population have a nominal size of about 255 μm or more (at least some particles having a nominal dimension of 255 μm) and so forth. When PSD is determined by the well-know laser-diffraction method described herein, the D₉₀ measurement depicts a volume average.

As used herein, the term “micron” or “μm” both are same refers to “micrometer” which is 1×10⁻⁶ meter.

The skilled artisan knows that the results of PSD determination by one technique can be correlated with that from another technique on an empirical basis by routine experimentation.

Thus according to an aspect of the present invention is provided Rasagiline mesylate having a 90 volume-percent of the particles (D₉₀) with a size of about 255 microns to about 590 microns obtained directly by crystallisation techniques and devoid of comminution techniques to control particle size.

Comminution as referred to herein refers to mechanical processes of reducing the size of particles which includes any one of cutting, chipping, crushing, grinding, milling and micronizing.

Thus according to another aspect of the present invention is provided a process for preparing particulate rasagiline mesylate, wherein at least 90% of the particles have a particle size of about 255 microns to about 590 microns, comprising the steps of:
i. providing a slurry of rasagiline mesylate in a suitable solvent.
ii. heating the slurry of step I to reflux temperature to obtain a clear solution;
iii. gradual cooling to room temperature;
iv. recovering rasagiline mesylate wherein atleast 90% of the particles have a particle size of about 255 microns to about 590 microns

Rasagiline mesylate suitable for use in step i can be obtained by any process known to one skilled in the art; for example by treating a solution of di-(R-(1)-N-propargyl-1-amino indan) tartrate or a solution of R (+) PAI with methane sulphonic acid in the presence of a suitable solvent by conventional methods as disclosed in U.S. Pat. No. 5,532,415.

Preferably, the slurry is heated to a temperature of about 25° C. to about 100° C., more preferably about 65° C. to obtain a clear solution. The solution preferably does not contain undissolved rasagiline mesylate.

Suitable solvents in which rasagiline mesylate is sparingly soluble may be used for providing a slurry as in step i. Such solvents are known in the prior art and would be evident to a person skilled in the art. These solvents may include alcohols, esters ethers, ketones, nitriles, hydrocarbons and the like or mixtures thereof. Preferably the solvent is an alcohol. More preferably the solvent is a C₁-C₈ alcohol which may be branched or unbranched. A preferred embodiment of the present invention employs isopropyl alcohol.

Particulate rasagiline mesylate wherein at least 90% of the particles have a particle size of about 255 microns to about 590 microns can be recovered from the suspension. For example, the solution of step ii is preferably cooled to a temperature of about 65° C. to about 30° C. Preferably the cooling is gradual and without stirring. Preferably the cooling is done over a period ranging over about 30 minutes to about 24 hours, more preferably to about 15 hours.

The suspension can then be filtered, preferably under vacuum.

The process of the present invention can be performed on an industrial scale.

### Instrumental Details

### Particle Size Method of Analysis:

Particle Size Distribution (PSD) is determined by laser diffraction in Malvern master Sizer 2000 equipment or its equivalent:

### Particle Size Distribution (by Laser Diffraction):

Instrument:

| | |
|---|---|
| Particle size analyzer | Malvern, Master sizer 2000 or equivalent |
| Technique | Dry dispersion method |

Analysis Parameters:

| | |
|---|---|
| Sample handling unit | Scirocco 2000 |
| Refractive index | 1.520 |
| Absorption | 0.1 |
| Dispersant R.I. | 1.000 |
| Analysis model | General purpose |
| Sensitivity | Normal |
| Measurement time | 6 seconds |
| Background time | 6 seconds |
| Vibration feed rate | 50% |
| Dispersive air pressure | 3.0 bar |
| Measurement Cycles | 3 measurements. |
| Distribution | Volume |

Procedure:

Spread sufficient powder in the dry powder holder of sampler holding unit and close it by the sliding cover. Operate the instrument for particle size analysis.

### Report:

Report the average of three measurements.

### Precautions:

1) Sample quantity should be sufficient to pass for 6 seconds of each measurement in order to maintain the required obscuration during measurement
2) Do cleaning after completing the analysis.

The following examples are intended to illustrate the scope of the present invention in all its aspects but not to limit it thereto.

### EXAMPLES

Although the invention has been described in terms of particular embodiments and applications, one of ordinary skill in the art, in light of this teaching, can generate additional embodiments and modifications without departing from the spirit of or exceeding the scope of the claimed invention. It should be emphasized that the above-described embodiments of the present invention, particularly any “preferred” embodiments, are merely possible examples of the invention of implementations, merely set forth for a clear understanding of the principles of the invention. Accordingly, it is to be understood that the drawings and descriptions herein are preferred by way of example to facilitate comprehension of the invention and should not be construed to limit the scope thereof.

### Example-1

Rasagiline mesylate (420.0 g) was added to isopropyl alcohol (4200 ml) taken in a R.B.F. The reaction mass was heated to 60-65° C. under stirring. The reaction mixture was maintained at the same temperature until a clear solution was obtained. Heating and stirring were stopped and the reaction mixture gradually cooled to room temperature in around 15 hours. The reaction mass was filtered under vacuum and dried under vacuum (650-750 mm Hg) at 60-65° C. for around 12 hours.

Dry wt=314 g. Yield=74 80%. Purity=99.6%. Particle size data (D₉₀)=292.2 μm.

### Example-2

Rasagiline mesylate (462.0 g) was added to isopropyl alcohol (4620 ml) taken in a R.B.F. The reaction mass was heated to 60-65° C. under stirring. The reaction mixture was maintained at the same temperature until a clear solution was obtained. Heating and stirring were stopped and the reaction mixture gradually cooled to room temperature in around 15 hours. The reaction mass was filtered under vacuum and dried under vacuum (650-750 mm Hg) at 60-65° C. for around 12 hours.

Dry wt=367 g. Yield=79.44%. Purity=99.3% Particle size data (D₉₀)=337.1 μm.

1. Rasagiline mesylate having a 90 volume-percent of the particles (D₉₀) with a size of about 255 microns to about 590 microns, wherein the particle size is controlled by crystallisation techniques and is devoid of comminution operations.

2. A process for preparing particulate rasagiline mesylate comprising the steps of:
i. providing a slurry of rasagiline mesylate in a suitable solvent.
ii. heating the slurry of step i upto reflux temperature to obtain a clear solution;
iii. gradual cooling to room temperature;
iv. recovering rasagiline mesylate wherein atleast 90% of the particles have a particle size of about 255 microns to about 590 microns.

3. The process according to claims 1 and 2 wherein the solvent is selected from a group comprising alcohols, esters, ethers, ketones, nitriles, hydrocarbons and the like or mixtures thereof.

4. The process according to claim 3 wherein the preferred solvent is an alcohol.
